(19) United States
(12) Patent Application Publication
(10) Pub. No.: US 2007/0071990 A1
(43) Pub. Date: Mar. 29, 2007

(54) Abradable dry powder coatings on piston assembly components

(76) Inventor: Andrew W. Suman, Waterford, MI (US)

Correspondence Address: CARGILL & ASSOCIATES, P.L.L.C., 56 MACOMB PLACE, MT. CLEMENS, MI, 48043, US

(21) Appl. No.: 10/596,162

(22) PCT Filed: Dec. 3, 2004
(86) PCT No.: PCT/US04/40388

§ 371 Date: Jun. 1, 2006

Related U.S. Application Data
(60) Provisional application No. 60/527,193, filed on Dec. 3, 2003.

(51) Int. Cl. B23K 35/36

(52) U.S. Cl. 428/548

(57) ABSTRACT

An abradable dry powder coating composition (20) for coating onto a piston assembly component (12) for subsequent curing to form into an abradable coating, including a powder (16) formed of uncured thermoset resin with at least 5 volume percent filler, wherein the filler does not substantially melt below the cure temperature of the resin. Method for making and coating the coating composition includes melt-mixing the thermoset resin with at least 5 volume percent of filler, cooling the resulting mass composite, and then breaking the cooled mass composite into powder particles (16). Method of coating an article with an abradable coating includes applying the dry composite powder with the filler therein onto the piston assembly component and curing the dry powder composition, preferably by electrostatic powder coating.

### CROSS REFERENCES TO RELATED APPLICATIONS

This application claims the benefit under 35 U.S.C. 119(e) of U.S. Provisional Application No. 60/527,193 filed on Dec. 3, 2003.

### BACKGROUND OF THE INVENTION

1. Field of the Invention

The present invention relates generally to dry powder compositions for forming abradable coatings, methods for making the compositions, and methods for coating articles with the compositions, and the coated piston assembly components themselves, such as pistons, piston rings, lands, cylinder bores, and other driven piston pump components.

2. Description of the Prior Art

In internal combustion piston engines and driven piston pumps, the operation relies on the relative movement of internal components to compress gases and pump liquids. For the highest operating efficiency of such devices, it is necessary to minimize clearances and leakage between the movable components. In some devices it is also advantageous to minimize friction between the movable components and/or between the components and the fluid being transferred. Abradable coatings are designed to be coated on the working surfaces of the pistons or pumps, which gradually abrade into nearly perfect fitting zero clearance surfaces when the engine or pump is first operated. Conventional abradable coatings are made of liquid materials which are sprayed or painted onto the working surfaces. Alternatively, the working surfaces can be dipped into the liquid abradable coating composition. The liquid coating may even be electrostatically painted on. Dry abradable coatings can be applied with thermal spray techniques.

In addition, it is well known that in an internal combustion piston engine or a driven piston pump, the tightest possible fit between the piston assembly and the bore is desired for maximum power, efficiency, and durability. Tighter piston clearances allow less piston rock, which reduces audible piston slap. Less piston rock also reduces ring flutter and ring distress, both of which erode the overall sealing performance of the piston/ring assembly in the bore. Tighter piston-to-bore clearances enable shorter piston skirts, which allow engine designs with stroke advantages and weight savings. Furthermore, less piston-to-bore clearance provides a better labyrinth seal, thereby reducing leakage from the compression chamber, which improves efficiency and protects crank case lubricants.

However, when the piston clearance is too tight, problems can occur, such as oil film breakdown, increased friction, higher temperatures, scuffing, scoring, and seizure. Therefore, engine and pump designers must balance the advantages of a tighter fit with the risks of poor durability and catastrophic failure. Ultimately, piston and bore machining tolerance capabilities require a clearance larger than the ideal performance fit.

Many piston skirt coatings have been used to reduce friction, reduce scuffing potential, and improve break-in reliability in pumps and engines. These improvements have allowed engine designs with somewhat tighter piston clearances. Piston skirts have been plated with metals such as tin, chrome and nickel to improve scuff resistance. However, plating operations are no longer desired due to environmental and cost issues. Furthermore, plated coatings are extremely thin, and do not effectively reduce piston noise or the running clearance of a piston bore pair.

Thermal spray coatings similar to those described in U.S. Pat. No. 5,976,695 issued to Hajmrle offer a wide variety of compositions and application techniques. They can be applied thick enough to tighten the running clearance. Thermal spray coatings use metallic or polymeric materials as binders and often contain solid lubricants such as graphite, molybdenum disulphide and others for friction reduction and scuff resistance. Some thermal spray coatings are abradable, meaning they will wear away where necessary to provide a better running fit of the piston in the bore such as U.S. Pat. No. 5,469,777 issued to Rao. The abradable characteristics are beneficial because they offer improved fit without requiring tighter, more costly machining tolerances. However, thermal spray coatings are very expensive due to costly equipment, sophisticated process controls, expensive consumables, and high raw material costs. These cost issues have limited the application of thermal spray coatings and prevented high volume piston market penetration.

Dipping, spraying, silk screening, sponge rolling and other techniques have been used to apply solvent based organic coatings to piston skirts and lands, as described in many patents, including U.S. Pat. No. 6,684,844 issued to Wang, U.S. Pat. No. 5,884,600 issued to Wang, U.S. Pat. No. 5,469,777 issued to Rao, U.S. Pat. No. 5,313,919 issued to Rao, and U.S. Pat. No. 5,941,160 issued to Kato. Solvent based piston coatings have been developed to achieve tighter running clearances and reduce noise, friction and scuffing potential. Typical prior art volatile organic solvent compounds that were used as carriers are those that have a boiling point of less than 100° C. Examples of such VOCs are xylene, methyl ethyl ketone, acetone, and n-methylpyrolidone.

Conventional solvent-based coatings often include combinations of polymers and solid lubricants. Fluoropolymers, polyamides, polyamide-imides, and other polymer resins are often chosen as binders for their thermal, mechanical, and lubricious properties. Solid lubricants such as graphite, molybdenum disulfide and others provide some lubricity and scuffing protection even during periods of oil starvation.

These coatings also offer some noise damping and can be applied at increased thickness and are somewhat abradable so that the effective running piston clearance can be reduced in engines and pumps. For years, solvent based organic coatings incorporating solid lubricant particles have been used in piston engine racing applications. Recently, as traditional plating has become more expensive, solvent born piston coatings have enjoyed some growth into high volume applications such as production automobiles and motorcycles. However, wet processes, especially those using volatile organic solvents suffer from high costs related to solvent emissions, equipment maintenance, equipment cleaning, drying time, and curing time.

Moreover, these prior art liquid compositions have inherent problems, including cost for excessive material, environmental concerns arising from the use of the solvents, and the inability to recycle and re-use any overspray which is surely generated during any spraying or electrostatic applications. Dipping and roller painting may not generate much overspray, but they certainly generate toxic solvent fumes.

One example of the prior art is U.S. Pat. No. 5,554,020 issued to Rao, et al., which discloses providing a liquid abradable coating on both contacting surfaces in a gas compressor. Before start up, the coated contacting surfaces have an interfering fit, but upon start up the coatings on the two contacting surfaces abrade and grind against each other to a substantially zero clearance.

Rao, et al., uses either water-based or solvent-based resin formulations to coat the desired components and subsequently flash off the solvent or water and cure the resin. Rao, et al. 's formulations include the water or evaporative solvent along with certain solid lubricants, a thermoset resin selected from epoxy, polyamide, or polyaryl sulphone, and a polymerizing catalyst. Rao, et al., describes that the coating may be applied by (i) electrostatic or air atomized spray/or dip process or (ii) a smooth sponge roller. In the case of a spray process, a multi-layer coating is taught to be desirable.

Although Rao, et al., presents the above-described methods for achieving close clearances on pump components, their methods are not without problems and undesirably high manufacturing costs. For instance, when solvent-based formulations are used, removal, containment, and special handling of the solvent is required. Removal of the solvent or volatile organic compound from the coatings, which is completed before the curing process, requires additional heat, time, and handling equipment. The volatile organic compound requires additional care in handling for the safety and health of the operators and the environment. Due to solvent buildup, oven gases must be exhausted making it less energy efficient to cure. In addition, there is typically significant shutdown time necessary for cleaning and maintenance of solvent-processing equipment. Aside from the problems with processing with solvents, solvent-based materials also create unique problems and additional cost when transporting the materials.

Although the water-based systems are environmentally more favorable, there remains the additional cost and time of evaporating and handling the water from the coatings and the shutdown time for cleaning and maintenance of the equipment. Furthermore, not all resins can be formulated into water-based systems, so the types of resins available to use with water-based systems are limited.

Another disadvantage of spray coating liquid-based formulations is that it is not practical to recycle any overspray. Reclaimed overspray would require an inordinate amount of re-formulation to adjust its viscosity in order to achieve consistent coating results.

It would be advantageous to have an aspect of the present invention to include improved coatings which were easy to apply, cost effective, energy-wise, used relatively inexpensive and simple equipment, and were environmentally favorable with a faster cure cycle. It would also be advantageous if the composition for forming the abradable coatings was recyclable, to reduce loss during the coating process. Yet another advantage would be realized if any coating thickness can be achieved in one layer, thus, not requiring a multi-layer coating. Still a further advantage would be realized if the abrasion characteristics and lubricity of the coating could be controlled to best meet different applications.

### SUMMARY OF THE INVENTION

The present invention is a dry powder coating material and application process that can reliably deliver an abradable, durable, lubricious, oil retaining, sound damping piston assembly component coating in high volumes and at lower cost than the prior art. The properties and thickness range of the cured coatings allow reduced piston-to-bore clearances without the risks of oil film breakdown, increased friction, higher temperatures, scuffing or seizure.

In the present invention, pistons, piston rings, lands, and even cylinder bores can be coated to provide a better fit at the piston-to-bore interface. The various common applications for pistons include, but are not limited to, pistons in air compressors, refrigerant compressors, paint sprayers, hydraulic pumps, hydraulic control valves, plumbing valves for gasses and liquids, shock absorber pistons, brake pistons, hydraulic cylinder pistons, internal combustion engines, vacuum pump pistons, among others.

Upon installation and initial operation, or break-in, of the engine, pump, or compressor, the coating porosity and roughness of the coating allow controlled abrasion of the coating until the contact stresses match the coating material strength. After the complete break-in event, which includes full thermal cycling of the unit, the contact stresses are reduced to a level where the coating material has very good durability. The long term running clearance at the piston-to-bore interface is substantially tighter than is possible using machining alone to minimize the clearance. In addition, the worn surface structure contains pits and fissures which collect oil, and thereby help to maintain an oil film during the reciprocating motion of the piston.

The abradable powder coatings in the present invention use compositional and structural mechanisms to achieve quick break-in and long-term durability, especially in oiled applications. The roughness and porosity of the coating surface provides an easy run-in at high stress areas. Once the interference fit is worn away, the contact stress drops and allows long term durability with an improved fit. The remaining crevices and fissures in the pores of the coating surface hold oil and help maintain a hydrodynamic film. If persistent oil starvation occurs, the material may wear, releasing solid lubricant into the interface. These lubrication mechanisms enable designs to benefit from tighter piston-to-bore clearances while preventing scuffing and other destructive modes.

Abradable powder coatings can be achieved with formulations comprising 5 to 45 volume percent fillers, which substantially do not melt at the cure temperature of the resin binder system, thereby being able to achieve cross-linking of the resin while maintaining the integrity of the filler. The resin binder system makes up the remaining 55 to 95 volume percent of the solid portion of the coating. Porosity content plays an important role in achieving the desired coating structure and performance, as the oil of the engine is caught in, and rides in, the ligament walls of the pores that are not abraded away, as it actually provides a ready supply of lubricant oil film at the piston-bore surface.

The resin system of abradable composite powder coating materials can include other additives which add lubricity to the coating, and/or affect the final structure of the cured coating. Some categories of additives are classified as lubricants, waxes, film-formers, plasticizers and foaming agents. These additives can be used individually or in combination to create a wide variety of effects.

In accordance with the present invention, an abradable dry powder coating composition (20) for coating onto a surface (12) for subsequent curing to form into an abradable dry powder coating, includes a powder (16) formed of uncured thermoset resin with at least 5 volume percent filler wherein the filler does not substantially melt at or below the cure temperature of the resin. Filler is dispersed throughout the resin, where the filler particles become exposed when the pore ligaments wear. When both contacting surfaces have the abradable coating thereon, and the pump is started, these abradable pieces scrape against one another and form a smooth surface which does not allow leakage therepast.

When one of two mating surfaces has the abradable coating thereon, such as a piston in an internal combustion engine, the coating on the piston will wear to fit the bore during initial cycling up and down. The presence of the coating provides benefits in engine power through efficiency and piston/bore durability through reduced scuffing potential, among other benefits. An abradable powder coating could also be applied to the ring lands and/or the piston rings to help seal the ring to the piston and allow free motion of the piston ring in the ring groove so that good contact is maintained between ring and bore. Coating the ring outer diameter could also help with engine or compressor break-in and performance.

Another aspect of the present invention includes a method for making the abradable dry powder coating composition of the present invention which includes melt-mixing the polymeric components, such as the thermoset resin, with at least 5 volume percent of filler, cooling the resulting mass composite, and then breaking the cooled mass composite into tiny powder particles. This method produces a homogeneous powder particle composition suitable for use with the present invention.

Yet another aspect of the present invention is the practice of a method for coating a piston assembly component, such as a piston, piston ring, land or cylinder bore, either totally or intermittently, with an abradable coating made in accordance with the present invention by applying the dry composite filler-containing powder coating composition onto the piston assembly component and curing the dry powder composition. Electrostatic coating is the preferred application method. Although any suitable method for applying dry powder coating composition to a substrate may be utilized, the least waste is experienced when utilizing the electrostatic dry powder coating method. The present invention also includes a process and tooling for washing, masking, and coating piston assembly components, either in their entirety or on portions only, such as pistons, piston rings, and lands, which virtually eliminates waste during application and allows cost effective automation of high quality electrostatic coating processes.

Other advantages of the present invention will be readily appreciated as the same becomes better understood after reading the subsequent description taken in conjunction with the appendant drawings. Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention.

Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a cross-sectional view of a portion of the exterior coated surface of a piston assembly component coated according to the present invention;

FIG. 2 is a detailed microscopic view of a fresh coating of the abradable coating, showing the peaks and valleys before break-in which breaks off the asperities;

FIG. 3 is a detailed cross-sectional microscopic view of the same abradable coating after break-in, where it has been run against another surface with the abradable coating, showing the reduced coating height and the flattened contact areas with fissures, and also showing the pores still present at lower levels;

FIG. 4 is a photomicrographic photograph of a continuous textured piston coating before break-in illustrating the fissures and peaks and valley which improve the fit of the piston in the bore and prevent scuffing at the piston-bore interface;

FIG. 5 is a photomicrographic photograph of the continuous textured piston coating after break-in, illustrating the flattened areas with the asperities broken off and worn off;

FIG. 6 is a photomicrographic photograph of a non-continuous textured piston coating before break-in illustrating the bare metal located between the fissures, peaks and valleys of the coating material which improve the fit of the piston in the bore and prevent scuffing at the piston-bore interface;

FIG. 7 is a graph of a trolley tester test result for thickness vs. log cycles;

FIG. 8 is a graph of a trolley tester test result for thickness vs. log counter; and

FIG. 9 is a graph of a test result for diametric thickness break-in for a firing engine.

### DETAILED DESCRIPTION OF THE INVENTION

The present invention generally entails composite dry powder compositions for forming abradable dry powder coatings, methods for making and applying the composite powder compositions, and articles coated with the composite powder compositions. The abradable coatings formed from the composite powder compositions are especially useful for coating a component or components in a device in which the components are movable relative to each other and a minimum clearance between the components is desired, such as a pistons or piston rings in an internal combustion engine or a compressor. The composite powder composition may also be formulated to provide self-lubrication. To achieve the minimum clearance and optionally, lubricity, the component(s) is coated with the composite powder composition, which is subsequently cured. The coating is applied to a thickness such that the movable components may contact each other during initial operation of the device. Then, during initial use of the device, the coating(s) is worn down until an essentially zero clearance during operation is achieved. After initial break-in the coating remains in place to reduce clearances, prevent incidental contact between the surfaces, and maintain lubricity between the surfaces.

### I. The Coating Composition

In its simplest form, the composite powder composition is a dry powder which contains uncured thermoset resin and filler. The term “dry” is used to mean without evaporative carriers, such as volatile organic compounds (VOCs) or water as carriers for the powders, especially useful for powder coat applications.

The uncured thermoset resin may be a resin system which includes the resin polymer and a hardener, if needed for that particular resin. The hardener or other curing initiator induces crosslinking of the resin polymer within a specific temperature range, which provides strength and chemical and thermal resistance to the polymer matrix in the resultant coating. The type of thermoset resin employed is not limited. For example, the thermoset resin type may be acrylic, polyester, epoxy, allyl, melamine formaldehyde, phenolic, polybutadiene, polycarbonate, polydicyclopentadiene, polyamide, polyamide imide, polyurethane, silicone, and combinations of these resin types. The thermoset resin preferably has a curing temperature which is recommended by the manufacturer. Typical desirable powder coating resins begin to soften and flow around 200° F.-500° F. and require a cure temperature of about 250° F. to 550° F. for up to about 30 minutes for completion of the crosslinking reaction. Preferable resin systems have a cure time of about 10 minutes at about 330° F. Silicone may be used in combination with a heat curable amine adduct to provide a short cure cycle time of about 10 minutes, preferably.

An alternate to heat-curing resins includes UV-curable resins, as these resins are formulated to cure upon exposure to UV light. In cases when heat is not desirable or required to cure the resin, it is still preferred to heat the coating to a temperature in which the surrounding resin flows sufficiently to wet the surface of the substrate to improve adhesion. The fillers used with these types of resins are preferably substantially non-flowing at the melt temperature of the resin.

Examples of preferred resin systems include epoxy, high temperature epoxy, polyamide, polyamide imide, silicone, polyaryl sulphone, polyester, polyphenylene sulphide, other resins, and any combination of these which maintain some mechanical properties at the operating temperature of the piston engine, piston driven pump, or compressor. The content of resins may range from 35 percent to 95 percent of the composition by volume.

Some resin systems require or benefit from the addition of a hardener, a crosslinker, or an accelerator. These materials promote curing reactions for thermoset resins, and often improve strength, thermal resistance, chemical resistance, and adhesion of powder coatings. Examples include dicyandiamides, phenolic hardeners, solid amine adducts, amines, aromatic amines, creosol novolac hardeners, imidazole hardeners, and others. They can be added to abradable powder coatings in amounts ranging from 0 to 25 percent by weight of the resin system.

The filler may be formed of a material which does not melt substantially at the cure temperature of the resin and is employed in an amount of at least 5 volume percent based on the volume of the resultant composite powder composition as cured on the part, not including pore fraction. Once the composite powder composition is applied to the desired surface, the amount of filler, along with the fact that the filler does not substantially flow at the cure temperature, allows the composite powder composition to maintain much of its shape and position on the coated surface even during the curing process. The term “does not substantially flow at the cure temperature of the resin” or “which melts above the cure temperature of the resin” is used to mean that the filler preferably does not melt or flow at the cure temperature of the resin such that the filler does not contribute significantly to any change in the shape or position of the coating during the curing process. The level and type of filler also effectively raises the viscosity of the composite particles at the cure temperature so that wetting and sintering of the particles is limited as compared to typical decorative and other protective powder coatings. Surface roughness and porosity are present in the cured coating structure of the present invention, both of which enhance abradability and oil retention.

As mentioned, the composite powder composition performs best when the filler is used in an amount of at least 5 volume percent based on the volume of the composite powder composition. The preferred composite powder compositions employ between about 15 and 30 volume percent based on the volume of the resultant composite powder composition. Preferred composite powder compositions employ at most about 35 volume percent filler, and more preferred compositions employ about 25 volume percent filler, based on the volume of the resultant composite powder composition.

The filler may be selected from a variety of materials, including, but not limited to, metals, minerals, mineral substances, ceramics, polymers (including fluoro-polymers), silicon dioxide, titanium dioxide, gypsum, silicate minerals (such as talc and aluminosilicates), graphite, diamond, molybdenum disulfide, fluorides such as calcium fluoride, magnesium fluoride and barium fluoride, clays, dirt, wood, ash, pigments, magnetic materials, phosphorescent materials, cured resin systems, cured composite powder compositions made according to the present invention, and mixtures thereof.

Examples of clays which are suitable for the present invention include kaolin, mullite, montmorillonite, and bentonite. Examples of ceramics which are suitable for the present invention include boron nitride, boron carbide, mullite, tungsten carbide, silicon nitride and titanium carbide. Many fillers are available from Atlantic Equipment Engineers, a Division of Micron Metals, Inc., Bergenfield, N.J. Other suitable minerals may be selected from those having a MOH's hardness of between about 0 and 10, which includes minerals having MOH hardnesses from carnotite (with a hardness of 0) up to diamond (with a hardness of 10). Such an entire list of minerals are those available from Atlantic Equipment Engineers, described above, or any other supplier of minerals and mineral substances. Combinations of any of the above-listed fillers may also find advantages.

Examples of preferred fillers which do not substantially melt at the cure temperature of the preferred resins include solid lubricants such as graphite, PTFE, polyamide, polyamide imide, polyimide, boron nitride, carbon monofluoride, molybdenum disulphide, talc, mica, kaolin, the sulfides, selenides, and tellurides of molybdenum, tungsten, and titanium or any combination thereof. Other fillers may be added for corrosion resistance such as sacrificial metals. Preferred sacrificial metals are metals whose oxides are lubricious, especially when the pistons may be cycled intermittently with extended idle periods. The content of fillers in the resultant coating composition may range from 5 percent to 45 percent by volume.

For some applications, a blend of fillers, such as a blend of graphite and clay, is preferred. Especially suitable filler compositions include from about 30 to about 40 volume percent clay and from about 60 to about 70 volume percent graphite based on the resulting filler content. Other combinations may also be desirable. The graphite may be in the form of fibers pulverized to a size of from about 7 to about 30 micrometers in length, although it is believed that the preferred mean size is about 20 micrometers.

Fillers such as graphite, fluorides, talc, boron nitride, and molybdenum disulfide possess lubricating properties and, therefore, when used, provide lubrication properties to the coatings. In addition, using cured resin systems, which may include cured composite powder compositions of the present invention, as the filler material may offer some unique advantages. One advantage of using cured resin systems is the opportunity to recycle “lost” material, i.e., material that is scrapped from previous coating operations. Another advantage of using cured resin systems as the filler material is that abradability of the coating can be adjusted without significantly altering the performance of the powder during electrostatic application.

The composite powder compositions of the present invention may also contain polymers or polymer waxes. The addition of polymer waxes renders the final product softer, more easily abradable, and, therefore, less filler may be needed. Suitable polymers may include any uncurable thermoset resin or thermoplastic such as polyethylene, polypropylene, fluoropolymers, co-polymers and any combination thereof. Any monomer that will not react with the hardener may be suitable to add softness, yielding a more abradable coating, so long as it will not crosslink and become hard. Polymer waxes may also improve the performance of the composite powder during application. Various polymer waxes may be used, e.g., fluoropolymer wax, polyethylene wax and polypropylene wax. Polymer waxes are typically added at levels of from about 1 to about 20 volume percent based on the volume of the composite powder composition.

In addition, lubricants may be included, such as hydrocarbons and polymers like polyethylene, polypropylene, nylons, polymer waxes, oils, and others listed in the 1999 Modern Plastics Encyclopedia and Buyers Guide, McGraw-Hill Co., 2 Penn Plaza, N.Y., N.Y. Other lubricants include metallic stearates, fatty acids, fatty alcohols, fatty acid esters, fatty amides and others listed in said 1999 Modern Plastics Encyclopedia and Buyers Guide.

Another aspect of the present invention includes the use of foaming agents that can be used to alter the structure of the cured coating, thereby affecting its abrasion and wear characteristics. These foaming agents can be exothermic or endothermic, and examples include azodicarbonamide and others listed in the above-mentioned 1999 Modern Plastics Encyclopedia and Buyers Guide. Foaming agents which will release gas upon curing, produce celled wall structures having ligament pore walls, which are generally covered on the top. During the engine break-in procedure, the tops of the celled walls are abraded off, and the remaining maze-like structure shown in the figures act as conduits and carriers for oil which is very beneficial in the case of oil starvation. Ligament walls which are formed by the cells after the closed cell structure has been opened up, will abrade down to a point where there will be fissures and cavities between the ligament walls, something that would look like the Grand Canyon. In this comparison, the walls of the Grand Canyon would have flattened tops, and the fissures and cavities or valleys, would be capable of carrying a supply of oil to provide lubricants to the surface of the piston assembly component.

Preferably, the roughness of the textured coating is considerable before break-in, and is reduced after break-in. Typically, the textured coating of the present invention exhibits a roughness Ra value of from about 1 to about 2000 microinches, on the order of 100 to 150 microinches, and with an Rsk value of from about 10 down to about −150, on the order of −0.50 to about +2.0. After break-in, the textured coating has a surface roughness of a greatly reduced amount, on the order of 1 to 50 microinches, with an Rsk value in the negative realm of about −1.0 to about −2.0. The greater the negativity of the Rsk value, the more asperities that have been ground off and their matter being redistributed into the adjacent valleys.

### II. Method of Making the Powder Composition

Another aspect of the present invention includes a method of making the composite powder composition, which includes the steps of (a) mixing filler, resin and additive, if used, particles in the amounts according to the present invention to form a dry mixture; (b) pulverizing the mixture to obtain a more uniform particle size and dispersion in the mixture; (c) consolidating the mixture particles into small units; (d) admixing a hardener composition, if desired, with the small units of resin and filler; (e) melt-mixing the mixture of the resin, hardener, additives and filler to form a mass composite; (f) cooling the mass composite; and (g) breaking the cooled mass composite into powder particles, thereby forming the composite powder composition. Fluidizing agents, such as fumed amorphous silica or aluminum oxide, may be added to the mixture to improve fluidization during application, reduce clogging in electrostatic spray equipment, and reduce clumping during storage. Additional solid powders can be blended in with the composite powder before or during application. The pulverizing of the filler and resin particles may be performed using any suitable mixing equipment, such as tumbler mixers (e.g., cement mixers), medium or high intensity mixers, ball mills, attrition mills, and the like.

The pulverizing step may be performed either before, after, or during the above-described mixing step and is to form more uniform particle size distributions of the various components, to separate agglomerated ingredients, and to provide a more uniform dispersion of all the ingredients. The pulverizing step may be performed with any suitable grinding equipment, such as a hammer mill or ball mill or a high intensity mixer. Good results have been achieved when the resin and filler are ground to less than 2000 μm and 200 μm, respectively. It is preferable to achieve homogeneous particle size.

The third step, the consolidating step, is performed to maintain the distribution of resin, additive and filler and to improve throughput through a melt mixer, typically an extruder. The higher throughput is achieved by avoiding fluidization of the mixture in the extruder. Eliminating fluidization results in better mixing and, generally yields faster production rates. The consolidating step forms small units which are desirably similar in size to the hardener particles, which are preferably admixed with the resin and filler after the consolidating step. The similarly-sized hardener and units of resin and filler are designed to prevent segregation of any one material, especially in the feed hopper of the melt mixer, and maintain good distribution of all ingredients. Roll compacting or pressing is a suitable technique for performing the consolidation step.

The consolidation step may also be achieved by heating the pulverized mixture to the softening temperature of the resin and/or polymer and/or polymer wax particles, allowing sufficient time for wetting and sintering to occur, thus, forming a partially or fully-sintered bulk mass. Thereafter, the bulk mass would be broken into small units which are suitable for mixing with the hardener and feeding into the melt mixer. At this point, it is also advisable to form homogenously-sized particles and mixtures throughout the bulk of each individual particle itself. Once again, a homogeneous particle, throughout, is preferable.

Furthermore, another aspect of the invention discloses a consolidation step achieved by first making a paste-like mixture of the resin and filler in water or other liquid, forming small units of the paste-like mixture, and then drying the water or liquid from the small units.

The hardener, if needed, may be added to the resin and filler before consolidating, but as mentioned above, it is preferred to add the hardener after consolidation. Sometimes less hardener is required for the same resin hardness when the hardener is added after the consolidating step. It is suspected that when the hardener is added before the consolidation step, the hardener partially may react with the resin due to the frictional heat and pressure of the consolidation step.

After forming the desired small units from the consolidation step, it may be desirable to break the small units to more closely meet the particle size of the hardener. Once again, any suitable grinding, comminuting or granulating equipment may be used. The resin/filler/hardener mixture is then preferably fed through a melt-mixer (e.g., an extruder) to more intimately mix the components and to form a mass composite.

Alternative to the consolidation step, or in addition thereto, the melt mixer or extruder may be operated under vacuum to limit the fluidizing and segregation of the filler particles. Yet another alternative way to limit the fluidizing and segregation of the filler in the extruder is to wet the feed with water, then extrude the ingredients, wet, damp, or after drying of the feed. Still another method is to extrude the resin with a smaller amount of filler, granulate the extruded material, and repeat extrusion of the granulated material, with each extrusion adding more filler. With this method, it may be preferable to add the hardener before the last extrusion cycle so that crosslinking is minimized during extrusion.

The physical properties of the mass composite exiting the melt-mixer depend on the composition. However, it is often soft, deformable, and tacky. Upon exiting the melt-mixer, the mass composite is cooled to avoid reaction between the resin and the hardener. The cooling may be accomplished by chilled rolls, forced air cooling, or submersion in water, among other suitable techniques.

The cooled mass composite is then preferably comminuted to form the composite powder composition. The comminuting may be performed by an air classifier mill or other type of mill, and fumed silica may be added before, during or after final comminution to improve the performance of the powder during certain application methods. Typically, the comminuting is performed until the particle size is less than 100 μm, but the particle size may be larger, if desired. Sifting operations can be used to remove particles of large or small size. After sifting, separated size cuts may be re-blended to achieve specific coating structures or maintain stable performance of reclaim coating booths.

The above-described method of making the composite powder composition of the present invention may be simpler than that which is discussed above. For example, the mixing, pulverizing, and consolidating may not be required if the resin, filler, and hardener are supplied having similar particle sizes, thereby limiting segregation. If this is the case or if otherwise desired, the method of making the composite powder composition of the present invention may include (a) melt-mixing an evaporative-carrier-free mixture of the resin and at least 5 volume percent of the filler, based on volume of the composite powder composition, to form a mass composite, (b) cooling the mass composite; and (c) breaking the cooled mass composite into powder particles, thereby forming the composite powder composition.

Although the above-described method of making the composite powder composition is the preferred method, the composite powder composition may also be made by any other suitable method, including wet or dry milling the raw materials together. In this method, attrition mills or ball mills, etc., may be used. In the case of wet milling, the liquid would be removed from the composite powder composition prior to its application to a surface. However, quality of the product and throughput are typically improved with the melt-mixing procedure described above.

Once the composite powder composition has been made, it may be applied to the desired surface. The piston assembly component substrate may be formed of any material so long as that material withstands the cure temperature of the resin. Typically, the substrates are formed of iron, steel, aluminum alloys, magnesium alloys, titanium alloys, copper alloys, ceramic, polymeric, or composite materials. When electrostatic spraying is used to coat the substrate and the substrate is formed of a nonconductive material, the substrate may be coated first with a conductive primer or preheated before application. The surface should be clean, and phosphate or chrome conversion pretreatments may be used. Other surface preparations and sealers may also be applied to the surface prior to coating with the composite powder composition. Grit blasting, anodizing and other preparation steps may also be desirable prior to coating the substrates.

### III. Methods of Coating

Regarding coating methods, different modes of application may be used, e.g., (a) electrostatic spraying or electrostatic fluidized bed coating, (b) dipping hot surfaces into a fluidized bed, (c) dispersing the powder into an evaporative carrier to form a slurry and applying the slurry by spraying, dipping, rolling, screen printing, or film transferring, (d) pressing a tape or monolithic body of the powder onto a surface, (e) flame spraying, and (f) vacuum deposition. Many of these methods may be used to apply the coating on cold or hot surfaces. In regards to application method (c) described above, U.S. Pat. No. 5,965,213 dated Oct. 12, 1999, assigned to BASF COATINGS AG, is incorporated herein by reference to teach some techniques of coating with a slurry.

An optional pre-treatment of using a sealer, grit blasting, or shot peening is possible for improving the surface treatment. An optional step of phosphate washing may be performed thererafter. Other known pre-treatments may be useful for adhesion of the textured coating, such as a polymeric adhesive treatment. Plastic media blasting may also prove useful.

Structurally, the break-in event of abradable powder coatings involves the relatively easy wear of the uppermost asperities in the coating structure. Those asperities may be formed by the sintered topography of the homogeneous particles or by the ligament walls of the foamed up resin if a foaming agent is used. The fracture and wear of the asperities releases solid lubricant particles into the stressed area, protecting the piston and mating bore from scuffing. This scuffing protection mechanism is effective regardless of the piston or bore alloy or composite compositions, and is especially important during initial start-ups, cold starts, and oil starvation events. In the case of exposed ligament walls, oil is caught within the individual pore cells, ready to provide further lubrication. As the coating continues to wear, the asperities are worn down to their thicker bases, which have more cross-sectional area, and greater load carrying capability. The break-in is complete when the contact stresses no longer exceed the strength of the abradable powder coating structure. After break-in, the oil retaining properties and strength of the coating maintain the tight clearance piston-to-bore interface.

The roughness, porosity, and cohesive material strength of abradable powder coatings can be manipulated through formulation, manufacture, and cure conditions to provide a robust balance of clearance control, durability, oil film maintenance, and scuff protection on pistons. These characteristics are particularly advantageous in high volume engine building, where piston-to-bore clearances are governed by machining tolerances.

When coating with electrostatic powder coating equipment, the resistivity of the composite powder material and the particle size distribution of the composite powder material have a strong influence on the thickness distribution of coating on different areas of the substrate. Each filler and resin component individually contributes to the resistivity of the composite particles, as does the particle size distribution. Proper balance of high and low resistivity fillers, resins, polymer waxes, polymers and particle size distribution will provide the best thickness distribution on a particular part, such as a pump rotor. Application equipment parameters such as gun type, gun tip type, voltage, booth air flow, powder feed rate, and atomizing air also affect the thickness distribution of coating on a substrate. The deposition rate is also affected by the coating material and process parameters mentioned above.

The coating may be applied to basically any thickness. Typical coating thicknesses range from 20 to 500 μm after one application. Although multiple coatings are usually not necessary, multiple coatings may be applied, if desired. Multiple layers of various materials may be utilized to an advantage. When applying multiple coatings, each layer may or may not be cured prior to applying the following layer, depending on the desired result. In addition, it may be desirable to have multiple thin layers of coatings which could yield various gradient coatings, either thickness gradient or compositional gradient. A coating having a thickness gradient may be thin in one area on the surface and gradually thicken toward another area on the surface. Furthermore, a coating having a compositional gradient could change in composition from the interior of the coating to the exterior of the coating. Alternatively, numerous layers may exhibit a gradient coating which might include a softer layer under a harder layer such that the harder layer could make a nice “first cut” when the machine having the abradable coating incorporated therein first starts up. For example, the uppermost layer(s) may include WC or TiC ceramic filler, in order to be a powerful grinder. Then, the softer filler in an inner layer could include graphite filler to act as a “fine” polisher after the “rough” polishing action of the ceramic-filled upper layer.

Typical thicknesses are 10 to 100 μm as cured but coatings exceeding 200 μm thick have been deposited in a single application. Even thicker coatings can be applied, especially when multiple applications are cured on a substrate. Thin or thick coatings can be layered to incorporate different compositions, or blended powder compositions can be sprayed simultaneously to achieve special properties and structures. Depending on the application, the coating may be designed to abrade minimally, substantially, or completely through its thickness. These coatings are ideally suited for filling in gouged, scored, or otherwise recessed areas on pistons, rings, lands and bores, thereby restoring their functional shape. After coating, if desired, the final dimensions of an article can be conventionally machined, burnished, or installed so final fitting takes place during operation of the unit.

There are many methods of coating, many of which are described in our first patent. Automated electrostatic spray and electrostatic fluidized bed processes offer advantages of high volume throughput with minimal downtime, minimal material loss, and they avoid curing the powder onto masks, tooling and fixtures. Therefore, these methods offer economic advantages which are critical when addressing high volume piston applications such as automotive engines, brakes, and refrigerant compressors.

When the coating has been applied to hot surfaces, additional heat treatment may not be necessary. When the method applies the coating onto cold surfaces, it may be necessary to thermally treat the coating to cure the resin and provide wetting and bonding to the surface. After the coating is heated enough to wet the substrate, additional heat or UV radiation is required to cure the resin for strength and chemical and thermal stability. Typical heating methods include convective heating, radiant heating, infrared heating, inductive heating, and combinations thereof. When the resin employed is UV-curable, the coating may be heated just enough to melt the resin and, thereafter, is exposed to UV light to initiate crosslinking of the resin.

The substrate and coating must reach the cure temperature of the resin for the minimum period of time recommended by the manufacturer in order to achieve good adhesion and cure. However, the thermal history (temperature vs. time) may be adjusted to achieve desired product properties.

The cured resin/filler matrix of the resultant coating is formed of cured resin and at least 5 volume percent filler based on the volume of the resin/filler matrix, wherein the filler is formed of a material which melts above the cure temperature of the resin. Additives, if used, are also incorporated into the coating. Typically, when dry composite powder composition is applied and cured, the coating exhibits more porosity and roughness than coatings applied from an evaporative carrier and/or having less filler. Since the filler does not flow at the cure temperature of the resin, much of the coating maintains the shape as it was originally coated. The filler limits the wetting, sintering, and spreading of the powder particles during curing because the filler increases the viscosity of the coating at the cure temperature. In addition, the concentration level of the filler renders the coating more easily abraded, due to an increased number of asperities.

A shorter cure cycle using lower temperatures would be desirable, although curing is preferably from about 7 to about 20 minutes with current conditions, and most preferably about 10 minutes, at temperatures from around 250° F. to around 550° F., and most preferably at about 350° F. Additional hardener would shorten the cure time.

Powder coating processes can provide very high throughput with minimal downtime because the equipment has high deposition rates, high reliability, and allows for almost continuous operation. Powder coating materials require no adjustment or stirring as do liquid based coatings. Unlike wet coating processes which incur constant maintenance, cleaning, and disposal costs, dry powder coating processes require virtually no down time during set-up, operation, interruption, or at shut down.

Powder coating processes can employ a combination of robotics, fixed and movable masking, air knives, vacuums, and surface treatments so that the coating is only cured onto desired areas of the piston. In certain applications, it would be desirable to add the dry powder coating to predetermined areas, while it may be desirable to remove powder from undesirable areas before curing. In essence, powder can be masked off by a mask or powder can be vacuumed or sprayed off a particular area if powder is not desired. Air knives can blow off powder in a rather precise location. Vacuuming can also carefully remove powder. Masking can be used to either add powder to a particular spot, or masks can be used to prevent the deposition of a powder in a specific location.

Further, coating material which clings to tooling can be simply blown off with compressed air, collected and recycled to the spraying system with the overspray. No other prior art methods appear to offer these economic advantages, whether liquid based or thermal spray. Convection heating, infrared, inductive, or other heating methods, or a combination of heating methods, may provide the best coating structure on certain substrates due to improved control of the thermal history of the article during melting and curing of the powder coating.

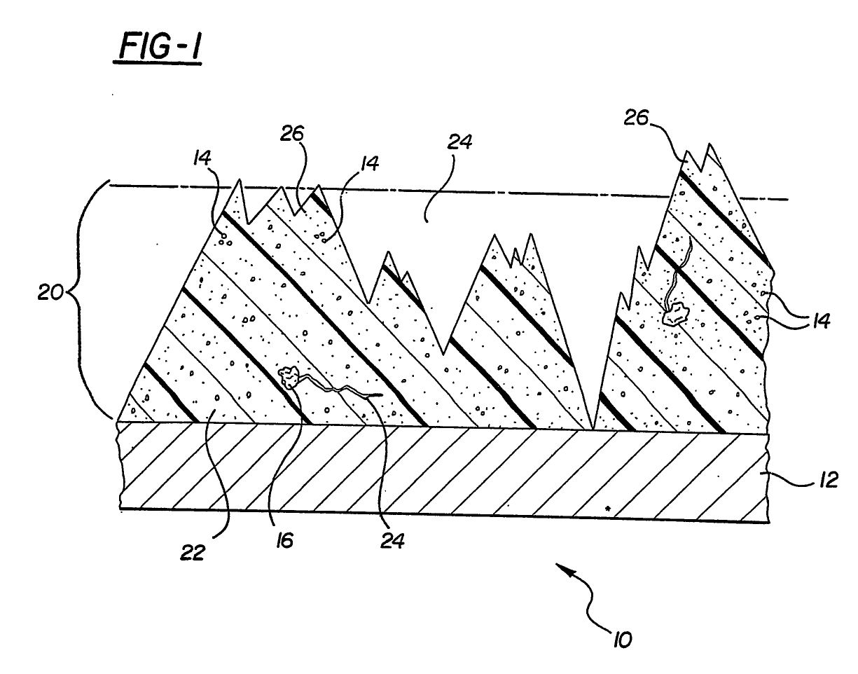

Looking first to FIG. 1, a simplified depiction of a typical coated article of the present invention is shown in FIG. 1 and generally denoted by the numeral 10. The figure shows a cross-sectional view of a portion of a generalized outer surface piston assembly component substrate 12 coated with a cured composite powder composition 20 of the present invention with filler 22 and resin 24. Coating 20 typically has the appearance of mountain tops 26, spreading at the surface of the substrate 12, yet maintaining some of the sprayed-on appearance due to the sintering of the coated material without much flow.

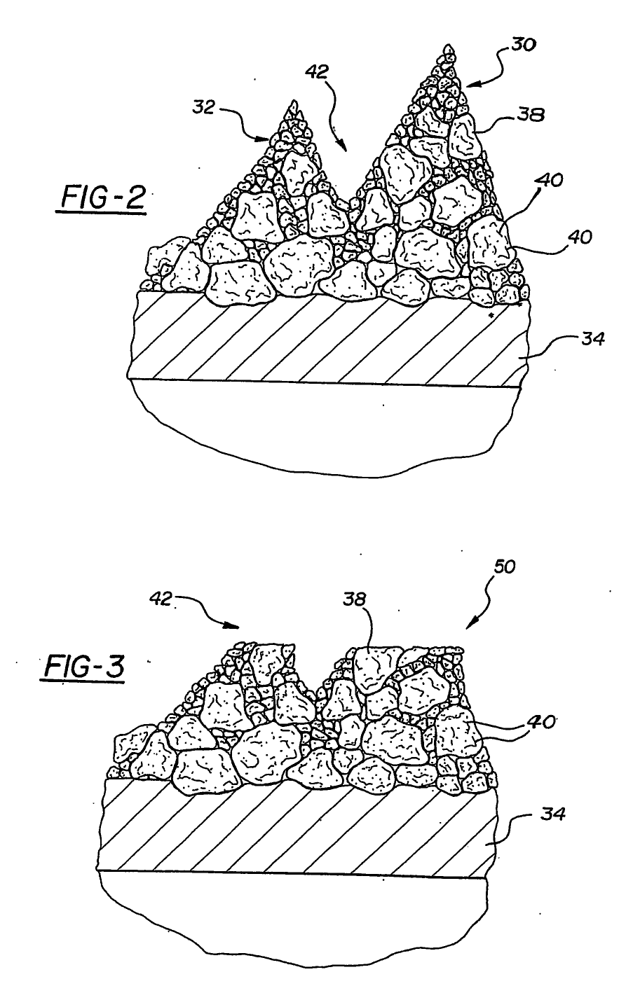

Looking next to FIG. 2, there is shown a detail of one of the peaks, or asperities 26 as illustrated in FIG. 1, where the peaked structure coating is generally denoted by numerals 30 and 32, and being made of individual powder granules 38 held together by the resin component at the points where they touch. Each powder particle is a homogeneous composition of the thermoset resin and filler. Filler 40 is shown as lines throughout the bulk of the individual powder granules themselves. Resin is shown having the filler therein, and the entire component rests on substrate 34. Valley 42 is shown between the peaks.

FIG. 3 illustrates the coating of FIG. 2 after break-in, where the peaks 30 and 32 of FIG. 2 have been abraded away, showing the flattened tops generally denoted by the numeral 50 with decreased valley depths 42. The valleys act to catch oil and provide lubricants during oil starvation situations. Filler materials 38 are exposed, although the shear off of the peaks expose the upper surface of particle 38. This greatly reduces scuff resistance in a piston assembly component.

Typical coatings of the present invention exhibit a mass of from about 20 to about 90 percent of the theoretical mass as calculated by geometric mass calculation. This decrease in mass is a further indication of the roughness and porosity of the coatings. More typically, the coatings of the present invention have from about 40 to 80 percent of the theoretical mass and, more typically, from about 50 to about 70 percent.

For example, for a non-porous material, the theoretical maximum density of a coating formed of a 30:70 graphite to resin ratio composition is about 1.46 g/cc. The mass of a 1 m² area of the hypothetical, non-porous cured coating having a 150 μm thickness is calculated by geometric mass calculation as follows:
(100 cm)²×0.015 cm×1.46 g/cm³=219 g coating

Typically, a coating formed of the same composition but applied from a liquid formulation, dried, and cured has a density which is about 95 percent of the theoretical density and the coating has a generally smooth surface. Note that the exact density and surface texture depends on the application and curing conditions. The mass of a 1 m² area of the prior art, liquid-applied cured abradable coating having a 150 μm thickness is calculated by geometric mass calculation as follows:
(100 cm)² ×0.015 cm×0.95×1.46 g/cm³=209 g coating

It can be seen from the geometric mass calculations that the mass of the exemplary coating formed from the liquid-applied formulation is about 95 percent of the theoretical mass.

In contrast, for a composite powder composition of the present invention containing graphite and resin in a ratio of 30:70, the coating may, for example, reach 65 percent theoretical density and have a rough exterior surface. The mass of a 1 m² area of the coating having a thickness of 150 μm is calculated by geometric mass calculation as follows:
(100 cm)²×0.015 cm×0.65×1.46 g/cm³=142 g coating

It can be seen from the geometric mass calculations that the mass of the coating of the present invention has a density which is 65 percent of the theoretical mass. The mass calculations are performed using geometric mass and include the full thickness of the coating because the density of the coating may vary from the interior surface to the exterior surface.

Although from the above-cited examples, it would appear that the present invention utilizes approximately one-half of the weight for a similar coating on a one-square metered area, this belies the fact that in the application of a liquid applied abradable coating as taught by the prior art, approximately 1,200 grams of coating mixture must be used to achieve the coating area and thickness in the example calculation above, and none of the overspray which occurs from the liquid applied abradable coating may be reused, such as with the present invention.

Therein lies one of the greatest advantages of the present invention, in which any additional powder composition can be reused and recycled, without any deleterious effects to the coating itself. With the use of a spray, such as described above with regards to the 1,200 grams of coating material, there are two separate sources of losses of material and weight, those being 1) overspray and 2) liquid carrier evaporation. In the prior art methods of liquid dipping, screen printing, or sponge rolling, the abradable coating onto the substrate, less material, is lost because there is no overspray. However, the liquid carrier evaporation still accounts for a significant portion of the weight of the coating, as disclosed above wherein the present invention utilizes approximately 150 grams of coating, while the liquid dipped abradable coating utilizes approximately 500 grams of coating, which releases nearly 300 grams of evaporative carrier into the atmosphere. Needless to say, this causes environmental issues and hazards to the health of workers in the nearby vicinity if the liquid carrier contains volatile organic compounds.

The porosity and roughness of the coating presents another advantage to the user, in that less coating material is required to achieve the desired thickness of abradable coating than with prior coatings which are not as porous or rough. The coatings of the present invention are typically softer than decorative and protective paint coatings. ASTM D-3363 is a test for measuring pencil hardness in which the following scale is used to report the result:
Hardest 6H 5H 4H 3H 2H H F HB B 2B 3B 4B 5B 6B Softest

The coatings of the present invention preferably have a pencil hardness of from about 6H to about 2B as measured using ASTM D-3363. The roughness of the coating being tested should be indicated as a deviation or special condition. More preferably, the coatings of the present invention have a pencil hardness of from about F to about 5H and, most preferably, from about 2H to about 4H.

After melting the coating to wet the coating onto the substrate, the partially cured coating can be formed, shaped or sized. This mechanical forming can be done by blowing air, contact rollers, scrapers, or other mechanical devices. The softened coating may be moved, thinned, accumulated, or otherwise manipulated to a desired location, shape or thickness, depending on the application.

After curing, the device, such as a pump or compressor, or engine may be assembled and operated using the coated components therein. Upon initial operation of the device, the portion of the abradable coating which has an interference fit between mating parts, may be worn away to result in an essentially zero clearance during operation of the device. In addition to achieving such a desirable clearance, the coating may be of such a composition that it is self-lubricating, decreasing friction between components within the device or between the coated surface and the fluid passing therethrough.

### EXAMPLES

### Example 1-7

Composite powder compositions were prepared from the following formulations using the method described above. Formulations of Examples 1, 3-5 and 7 resulted in good product. It is anticipated that Examples 2 and 6 will also result in good product. All weights are given in kilograms.

| Ingredient | Ex. 1 | Ex. 2 | Ex. 3 | Ex. 4 | Ex. 5 | Ex. 6 | Ex. 7 |
|---|---|---|---|---|---|---|---|
| ECN bis A epoxy | | 180 | 82.5 | 60 | 47 | 47 | 60 |
| Type 3 epoxy | 15.8 | 720 | 288.75 | 120 | 108 | 50 | 120 |
| Type 3.5 epoxy | | | | | | 24 | |
| masterbatch | | | | | | | |
| EPN modified type | 10 | | | 120 | 101 | | 120 |
| 7 epoxy | | | | | | | |
| Type 4 epoxy | 18 | | | | | 24 | |
| CTBN modified | | | | | | | |
| silicone resin | | | 412 | 300 | | 61 | 300 |
| silicone resin | | | | | 122 | 61 | |
| polyamide-imide | | 120 | | | | | |
| kaolin | 12 | 120 | 256 | 100 | 74 | 74 | 50 |
| graphite - 25 um | 36 | | | 300 | 223 | 223 | 280 |
| graphite - 75 um | | 480 | 418 | | | | |
| molybdenum | | | | | | | |
| disulfide - 5 um | | | | | | | |
| solid epoxy | 2.8 | | 18.5 | 15 | 19 | | 15 |
| amine adduct | | | | | | | |
| solid aromatic | | | | | | 24 | |
| amine hardener | | | | | | | |
| cresol novolac | | 198 | | | | | |
| hardener | | | | | | | |
| prepared wax | | | | | | 18 | 70 |
| prepared wax | | | 45 | | | | |
| prepared wax | | 25 | | | | | |
| p-toluene sulfonyl | | 15 | | | | | |
| hydrazide | | | | | | | |

* Cured composition has the same composition, but cured and in powder form.

The industrial applicability of the present invention includes the coating of components in pumps, compressors, engines, medical devices, and in any device which has moving parts. Parts such as pistons, piston rings and piston bores may be typical substrates. The present invention provides a composition for forming improved abradable coatings, methods of making the improved coatings, improved methods of coating components with abradable coatings, and the improved coated components themselves.

The coating of Example 4 was dispersed and compounded by a double extrusion technique which is most convenient for a small batch size. All the resin components excluding the hardener were mixed with approximately half of the graphite/kaolin filler blend extruded in a Theyson TSK-TT 020/16D extruder. Immediately after extrusion, the material was cooled in a chill roll to form a thin taffy. The taffy was smashed into chips which could be fed back into the extruder. The chips were blended with the hardener and the remainder of the filler mix. This mixture contained the full composition of Example 4 and was re-extruded and chill rolled into thin taffy. The taffy was smashed into chips and dry blended with 0.4 weight percent Aerosil 200 before final grinding. Final grinding was accomplished using a McHattie #3 PCG grinder and sifted through a 37 um mesh screen on a rotary sifter. The resulting material was used to coat QD-35 panels from Q-Panel for wear testing, and a piston from a 1993 Ford Escort using a Wagner PEM C-2 electrostatic powder coating gun.

The wear test panels were cured in a convection oven for 7 minutes at 290° F., and then ramped to and held at 360° F. for a total of 20 additional minutes. However, complete curing can be achieved in under 10 minutes at 330° F.

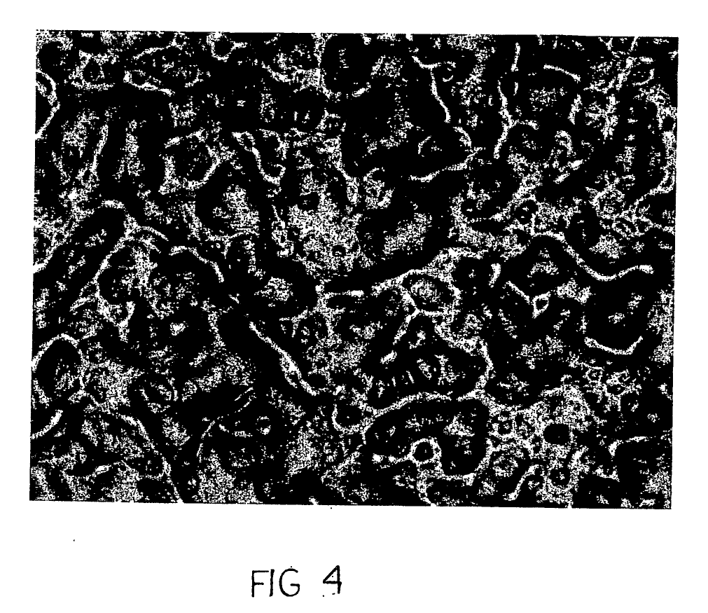

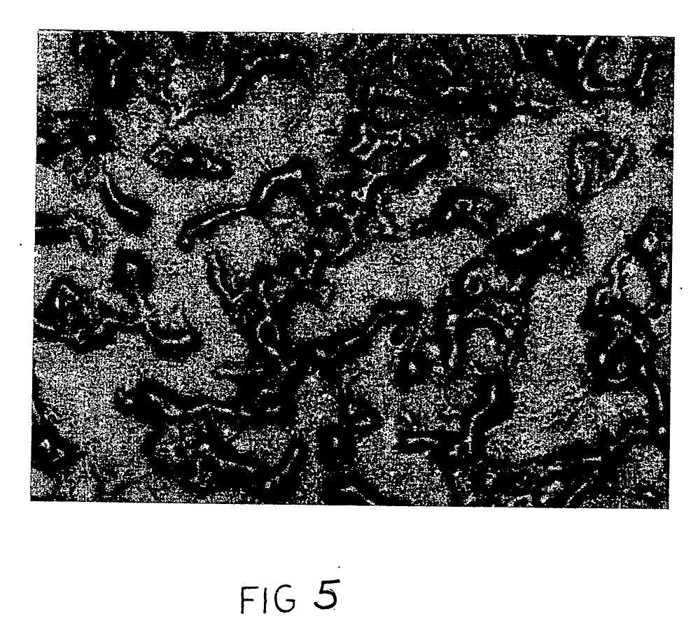

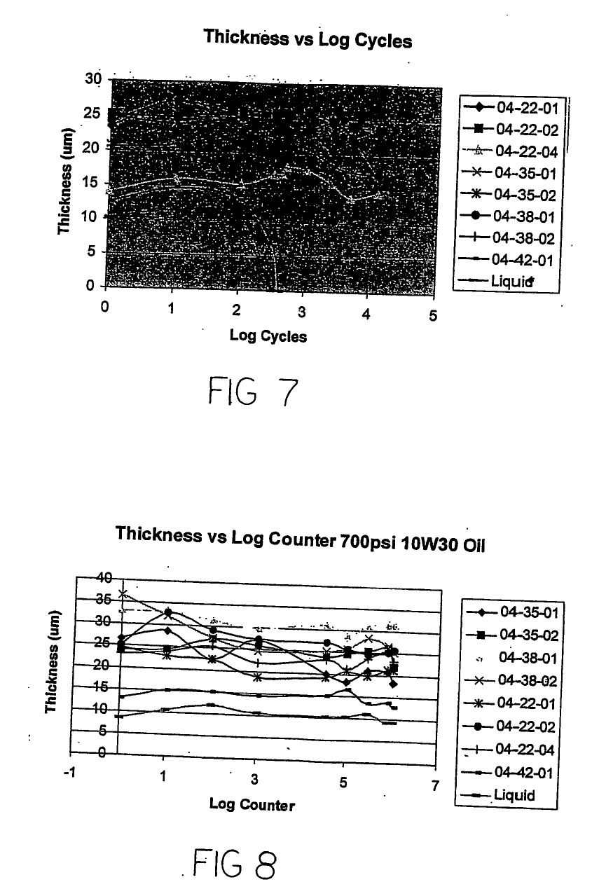

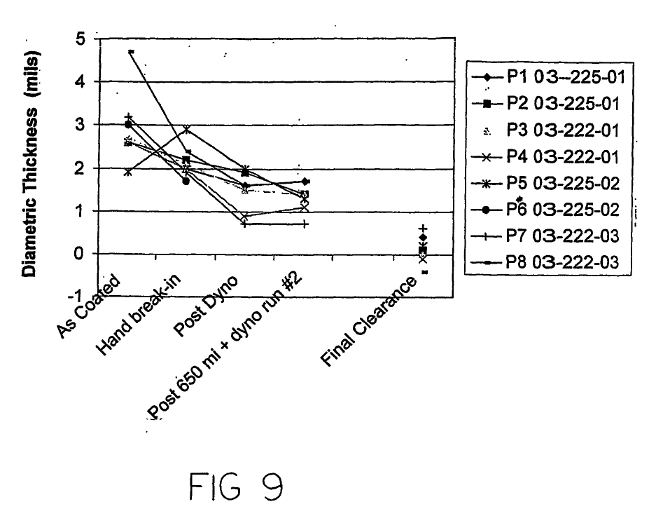

FIG. 4 is a photomicrograph of a continuous coating of the above described textured coating before break-in, and illustrates the fissures and valleys of the texturing. FIG. 5 shows the same coating after break-in, illustrating the new configuration, with flattened tops of the asperities as the schematic diagram of FIG. 3. All of the abradable powder coatings in FIGS. 7, 8 and 9 exhibited an early thickness reduction, or break-in, in the first cycles of the wear test. The thickness reduction upon initial break-in is obvious when the wear path is measured with micrometers, viewed optically, or touched. However, the break-in is less pronounced when measured using a magnetic thickness probe which tends to slip off the asperities down into the pits of the abradable powder coating surface. FIGS. 7 and 8 are constructed using proximity probe data, so the break-in event is less pronounced in this graph. FIG. 9 illustrates the break-in event as measured with micrometers on pistons which were installed into a firing engine. The piston was heated in a convection oven at 400° F. for 25 minutes. This piston exhibited good fitting characteristics and durability in firing engine testing.

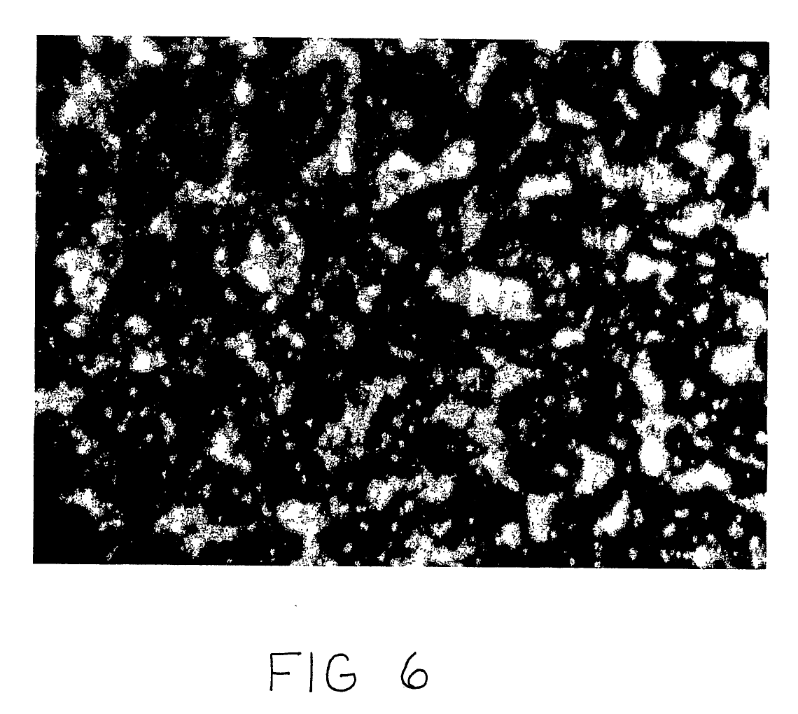

FIG. 6, on the other hand, shows a non-continuous textured coating of a piston assembly component, where bare metal can be seen between the non-continuous coated areas of the surface. Particularly, one can imagine that the coating is like a series of individual beads that have been adhered to a surface that started to flow out upon heating/curing, but did not include enough meltable material to completely cover the surface. Hence, the non-continuously coated piston surface. The non-continuous coating provides an oil reservoir.

FIG. 7 and FIG. 8 illustrate the thickness of the coating versus various parameters, including log cycle and log counter, respectively, for the various Examples shown in the Table hereinabove. FIG. 9 graphs out the diametric thickness of the coating during the break-in as it is occurring. Break-in consists of a firing engine test sequence that shows the interaction of the surfaces when the engine is first fired up and turned over. This is followed by a stabilized dimension at a substantially tighter piston clearance which in shown in the “Final Clearance” column. The measurements have been made with a micrometer and a dial bore gage.

The above examples are illustrative only and should not be construed as limiting the invention which is properly delineated in the appended claims.

The foregoing description of a preferred embodiment of the invention has been presented for purposes of illustration and description. It is not intended to be to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

### INDUSTRIAL APPLICABILITY

This invention finds applicability on any two contacting work surfaces, but is especially applicable to coating the contacting surfaces on pumps, rotors, pistons, piston rings, cylinder bores, and gas compressor components.

What is claimed is:

1. A coated piston assembly component, comprising:
a piston assembly component having a substrate surface; and
a textured coating on the surface of the substrate, the coating formed of a dry powder coating composition including a thermoset resin having a cure temperature combined with at least 5 volume percent filler based on the volume of the powder coating, wherein the filler is formed of a material which does not melt substantially at or below the cure temperature of the resin, the powder coating having a structure such that the coating has from about 20 to about 90% mass of its geometrically theoretically calculated mass, whereby an abradable coating results employing the filler which makes the coating abradable.

2. The coated piston assembly component according to claim 1, wherein the thermoset resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof.

3. The coated piston assembly component according to claim 1, wherein the filler is employed in an amount of at most about 45 volume percent based on the volume of the resultant composite powder composition.

4. The coated piston assembly component according to claim 1, wherein the filler is employed in an amount of from about 15 to about 30 volume percent based on the volume of the resultant composite powder composition.

5. The coated piston assembly component according to claim 1, wherein the coating is employed non-continuously of the composite powder composition.

6. The coated piston assembly component according to claim 1, wherein the filler is selected from the group consisting of metals, silicates, graphite, boron nitride, diamond, molybdenum disulfide, fluorides, clays, dirt, wood, ash, pigments, ceramics, polymers, silicon dioxide, titanium dioxide, gypsum, phosphorescent materials, cured resin systems, cured composite powder compositions, and mixtures thereof.

7. The coated piston assembly component according to claim 1, wherein the dry composite powder composition further contains a polymeric material selected from the group consisting of polymers, non-activated thermoset resin, thermoplastics and polymer waxes.

8. The coated piston assembly component according to claim 7, wherein the powder composition further contains a polymer wax selected from the group consisting of fluoropolymer wax, polyethylene wax and polypropylene wax.

9. The coated piston assembly component according to claim 1, wherein the coating powder composition further contains a foaming agent that is gas-producing when heated, such that the coating includes gas voids with ligament walls after curing.

10. The coated piston assembly component according to claim 1, wherein the textured coating has a roughness Ra value of from about 1 to about 2000 microinches.

11. The coated piston assembly component according to claim 1, wherein the textured coating has an Rsk value of from about 10 down to about −150.

12. The coated piston assembly component according to claim 1, wherein the textured coating is coated to a thickness of from about 5 to about 250 micrometers thick.

13. The coated piston assembly component according to claim 12, wherein the textured coating is coated to a thickness of from about 15 to about 80 micrometers thick.

14. A coated piston assembly component, comprising:
a piston assembly component having a substrate surface; and
a textured coating on the surface of the substrate, the coating formed of a dry powder coating composition including an uncured thermoset resin having a cure temperature, wherein the thermoset resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof, in combination with a second component, including at least 5 volume percent filler based on the volume of the resultant composite powder composition, wherein the filler is formed of a material which does not substantially melt at or below the cure temperature of the resin, and wherein the filler is selected from the group consisting of metals, minerals and mineral substances having MOH's of between 0 and 10, silicates, graphite, boron nitride, diamond, molybdenum disulfide, fluorides, clays, dirt, wood, ash, pigments, ceramics, polymers, silicon dioxide, titanium dioxide, gypsum, phosphorescent materials, cured resin systems, cured composite powder compositions, and mixtures thereof; and
a polymeric material selected from the group consisting of polymers, non-activated thermoset resin, thermoplastics and polymer waxes selected from the group consisting of fluoropolymer wax, polyethylene wax and polypropylene wax,
whereby an abradable coating results on the piston assembly component, and said coating employing the filler which makes the coating abradable.

15. A method of making a composition for coating a piston assembly component with a coating curable into an abradable coating, comprising:
melt-mixing an evaporative carrier-free mixture of a dry powder thermoset resin having a cure temperature, and at least 5 volume percent of filler, based on the volume of the resultant composite powder composition, to form a mass composite, wherein the filler is formed of a material which does not substantially melt at or below the cure temperature of the resin;
cooling the mass composite; and
breaking the cooled mass composite into powder particles, thereby forming the composite powder composition.

16. The method according to claim 15, further comprising consolidating the resin and the filler together into small units before the melt-mixing step.

17. The method according to claim 15, further comprising:
consolidating the resin and the filler together into small units; and
mixing a hardener with the small units before the melt-mixing step.

18. The method according to claim 15, wherein the resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof.

19. The method according to claim 15, wherein the filler is employed in an amount of at most about 45 volume percent based on the volume of the composite powder composition.

20. The method according to claim 15, wherein the filler is employed in an amount of from about 15 to about 30 volume percent based on the volume of the resultant composite powder composition.

21. The method according to claim 15, further comprising:
consolidating the resin and the filler together into small units; and
mixing a silicone resin and an epoxy amine adduct with the small units before the melt-mixing step.

22. The method according to claim 15, wherein the filler is formed of a material selected from the group consisting of metals, minerals and mineral substances having MOH's of between 0 and 10, silicates, graphite, diamond, molybdenum disulfide, fluorides, clays, dirt, wood, ash, pigments, ceramics, polymers, silicon dioxide, titanium dioxide, gypsum, phosphorescent materials, cured resin systems, cured composite powder compositions and mixtures thereof.

23. A method of making a composition for coating a piston assembly component with a coating curable into an abradable coating, comprising:
melt-mixing an evaporative carrier-free mixture of a dry powder thermoset resin having a cure temperature, wherein the resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof, and at least 5 volume percent of filler, based on the volume of the resultant composite powder composition, wherein the filler is formed of a material which does not substantially melt at or below the cure temperature of the resin, and wherein the filler is formed of a material selected from the group consisting of metals, minerals and mineral substances having MOH's of between 0 and 10, silicates, graphite, diamond, molybdenum disulfide, fluorides, clays, dirt, wood, ash, pigments, ceramics, polymers, silicon dioxide, titanium dioxide, gypsum, phosphorescent materials, cured resin systems, cured composite powder compositions and mixtures thereof, to form a mass composite;
cooling the mass composite; and
breaking the cooled mass composite into powder particles, thereby forming the composite powder composition.

24. A method of making a composition for coating a piston assembly component with a coating curable into an abradable coating, comprising:
consolidating an evaporative carrier-free mixture of a dry powder thermoset resin having a cure temperature, wherein the resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof, together with at least 5 volume percent of a filler, said volume percent being based on the volume of the resultant composition, wherein the filler is formed of a material which does not substantially melt at or below the cure temperature of the resin, and wherein the filler is formed of a material selected from the group consisting of metals, minerals and mineral substances having MOH's of between 0 and 10, silicates, graphite, diamond, molybdenum disulfide, fluorides, clays, dirt, wood, ash, pigments, ceramics, polymers, silicon dioxide, titanium dioxide, gypsum, phosphorescent materials, cured resin systems, cured composite powder compositions and mixtures thereof, to form a consolidated resin-filler composition of small units;
melt mixing the small units of consolidated resin and filler composition to form a mass composite;
cooling the mass composite; and
breaking the cooled mass composite into powder particles, thereby forming a composite powder composition suitable for use as an abradable coating.

25. The method according to claim 24, further comprising:
consolidating the resin and the filler together into small units; and
mixing a hardener with the small units before the melt-mixing step.

26. A method of coating a piston assembly component with an abradable coating, comprising:
powder coating onto a piston assembly component a dry composite powder composition containing a powder mixture of a thermoset resin having a cure temperature and at least 5 volume percent of filler, based on the volume of the composite powder composition; and
curing the applied composite powder composition.

27. The method according to claim 26, wherein the resin is selected from the group consisting of acrylic, polyester, epoxy, allyl, melamine formaldehyde, phenolic, polybutadiene, polycarbonate, polydicyclopentadiene, polyamide, polyamide imide, polyurethane, silicone, and combinations thereof.

28. The method according to claim 26, wherein the filler is employed in an amount of at most about 45 volume percent based on the volume of the composite powder composition.

29. The method according to claim 26, wherein the coating is employed non-continuously of the composite powder composition.

30. The method according to claim 26, wherein the filler is employed in an amount of from about 15 to about 30 volume percent based on the volume of the resultant composite powder composition.

31. The method according to claim 26, wherein the filler is formed of a material selected from the group consisting of metals, minerals and mineral substances having MOH's of between 0 and 10, silicates, graphite, diamond, molybdenum disulfide, fluorides, clays, dirt wood, ash, pigments, ceramics, polymers, silicon dioxide, titanium dioxide, gypsum, phosphorescent materials, cured resin systems, cured composite powder compositions and mixtures thereof.

32. A method of coating a piston assembly component with an abradable coating, comprising:
applying, to a piston assembly component, a dry composite powder composition containing a powder mixture of a thermoset resin having a cure temperature and at least 5 volume percent of filler, based on the volume of the composite powder composition; and
curing the applied composite powder composition.

33. The method according to claim 32, wherein the step of applying is accomplished by electrostatic powder coating.

34. The method according to claim 32, wherein the step of applying is accomplished by electrostatic fluidized bed coating.

35. The method according to claim 32, further comprising masking off certain portions of the piston assembly component prior to applying the dry composite powder composition to the surface of the piston assembly component.

36. The method according to claim 32, further comprising air knifing off certain portions of the dry powder application to the surface piston assembly component prior to curing the dry composite powder composition onto the surface of the piston assembly component.

37. The method according to claim 32, further comprising vacuuming off certain portions of the dry powder application to the surface piston assembly component prior to curing the dry composite powder composition onto the surface of the piston assembly component.

38. The method according to claim 32, further comprising air spraying off certain portions of the dry powder application to the surface piston assembly component prior to curing the dry composite powder composition onto the surface of the piston assembly component.

39. The method according to claim 32, wherein the step of curing is accomplished by heating by a method selected from the group consisting of an oven, infra-red heaters, convection heaters, induction heating, radiant heating, open torch flames, and localized open flame application.

40. The method according to claim 32, further comprising an additional step of modifying the uncured powder coating on the piston assembly component before curing the coating, where by the uncured powder coating is pushed into a desirable configuration.

41. The method according to claim 32, further comprising an additional step of partially heating and curing the coating to allow working of the uncured powder coating on the piston assembly component to achieve a desired configuration, followed by further heating to fully cure the resin until hard.
